(19) United States
(12) Patent Application Publication
(10) Pub. No.: US 2009/0177987 A1
(43) Pub. Date: Jul. 9, 2009

(54) Efficient display of objects of interest to a user through a graphical user interface

(76) Inventor: Prasantha Jayakody, Seattle, WA (US)

Correspondence Address: OLYMPIC PATENT WORKS PLLC, P.O. BOX 4277, SEATTLE, WA, 98104, US

(21) Appl. No.: 12/006,821

(22) Filed: Jan. 4, 2008

(51) Int. Cl. G06F 3/048

(52) U.S. Cl. 715/764

(57) ABSTRACT

Embodiments of the present invention include methods and systems for efficient display of object of interest within, or superimposed over, a display of a region of interest. In one embodiment of the present invention, when more than a threshold number of objects of interest need to be displayed, a portion of the objects of interest are graphically emphasized, or displayed using large, easily identified and manipulated icons, while the remaining objects of interest are displayed using small icons, or graphically deemphasized. A user may select an alternative portion of the objects of interest for graphical emphasis, deemphasizing any formerly emphasized objects of interest and leaving deemphasized any object of interest not within the alternative portion of the object of interested selected for emphasis.

### TECHNICAL FIELD

The present invention relates to graphical user interfaces and, in particular, to an efficient method and system for displaying objects of interest to users with respect to display of an underlying region of interest.

### BACKGROUND OF THE INVENTION

Early computer systems were room-sized machines which were programmed using enormous decks of mechanically punched cards and which output data to line printers and teletype machines by printing alphanumeric output to sheets of paper. Over the past 50 years, computers have increased enormously in computational power, flexibility in input and output, data-storage capacity, user-friendliness, interconnectivity, and variety of applications. Currently, computing devices are incorporated into a plethora of different types of consumer devices, from automobiles and kitchen appliances to cell phones. Modern personal computers have greater computational power than supercomputers had 20 years ago, and feature easy-to-use graphical interfaces for input and output of data and commands. However, these easy-to-use features are provided at substantial computational overhead. In many applications, the graphical user interface consumes greater than 90% of the total computational overhead of the application, and a significant portion of the hardware cost and complexity is devoted to providing high-speed internal communications, specialized processors, and memory devices to enable high-resolution graphics and image display.

As the variety of applications of computers has grown, a corresponding greater effort is needed to balance a desire to provide the high-end graphical user interfaces familiar to personal-computer users with size, power, and computational constraints of specialized computing devices included in various computational devices. For example, in hand-held, portable devices, including cell phones, the power supply comprises chemical batteries, which have limited power-provision duration. Power needs to be carefully managed, in such devices, to ensure the longest possible communications service cycle between battery recharging. Were excessive power used to run large, high-resolution graphical interfaces, the usefulness of the cell phone as a communications device would be compromised. Furthermore, consumers desire small hand-held devices that are convenient to carry and operate. At the same time, consumers increasingly desire the convenient, high-resolution and highly capable graphical user interfaces that they have grown accustomed to using with personal computers, particularly since the number and sizes of input keys are quite limited.

Currently, many portable hand-held devices, including cell phones, provide small, relatively low-resolution LED display screens for displaying menus and various types of information, both because the devices are small, and offer only small surface area for displays, and because the power requirements of small, relatively low-resolution LED display screens are more manageable for many portable, hand-held devices. When the sizes of the menus increase beyond what can be displayed conveniently on the display screen, or when the amount of data that needs to be displayed to a user increases beyond a threshold amount of data that can be legibly rendered on the display screen, multi-screen menus and data display are provided, requiring a user to page through a menu or through data display using keypad input to control page sequencing. However, multi-screen menus and data display may be awkward, time consuming, and inefficient for hand-held device users. Therefore, designers, manufacturers, vendors, and users of various types of small, hand-held consumer devices have recognized a need for more efficient methods and systems for displaying information and receiving input from users, and, while not as critical for more capable devices, including personal computers, efficient methods and systems for displaying information and receiving input from users may also find applicability in personal computers, workstations, and other devices accessed through graphical user interfaces.

### SUMMARY OF THE INVENTION

Embodiments of the present invention include methods and systems for efficient display of objects of interest within, or superimposed over, a display of a region of interest. For example, objects of interest may include various geographical locations, such as store, theaters, museums, or other locations of interest that are displayed within a map of a geographical region that includes a particular city, or region within the particular city. As another example, objects of interest may include display racks or departments within a large store or shopping mall. In one embodiment of the present invention, when more than a threshold number of objects of interest need to be displayed, a portion of the objects of interest are graphically emphasized, or displayed using large, easily identified and manipulated icons, while the remaining objects of interest are displayed using small icons, or graphically deemphasized. A user may select an alternative portion of the objects of interest for graphical emphasis, deemphasizing any formerly emphasized objects of interest and leaving deemphasized any object of interest not within the alternative portion of the object of interested selected for emphasis.

### BRIEF DESCRIPTION OF THE DRAWINGS

FIG. 1 shows an exemplary display of a region of interest on a display screen of an electronic device.

FIG. 2 illustrates display of a number of objects of interest within the exemplary region of interest shown in FIG. 1, along with navigational keys.

FIG. 3 illustrates display of a portion of the number of objects of interest shown in FIG. 2, along with corresponding keys, within the exemplary region of interest shown in FIG. 1.

FIGS. 4-6 illustrate display of a large number of objects of interest within the exemplary region of interest shown in FIG. 1 according to one embodiment of the present invention.

FIGS. 7-9 illustrate display of a large number of objects of interest within an exemplary region of interest, according to one embodiment of the present invention, on a display screen of a cell phone.

FIG. 10 shows data structure in one implementation of the present invention.

FIG. 11 is a control-flow diagram for a routine “POI Display” that represents one embodiment of the present invention.

FIG. 12 is a control-flow diagram of a routine “display bank” called in step 1106 of the routine “POI Display,” discussed with reference to FIG. 11.

FIG. 13 is a control-flow diagram for a routine “handle event” called in step 1114 of the routine “POI Display,” discussed with reference to FIG. 11.

### DETAILED DESCRIPTION OF THE INVENTION

Embodiments of the present invention are directed to methods and systems for graphical display of information to users of electronic devices. In one family of methods and system embodiments, objects of interest to a user are displayed within a region of interest. In certain instances, the objects of interest may be geographical positions, displayed within, or superimposed over, a geographical region. In other instances, the objects of interest may be other types of data objects within an underlying context, such as mechanical parts within a machine, or variables within the text of a program. In general, the context, or region of interest, is displayed as an image on a display screen of an electronic device, and the objects of interest are displayed as graphical icons, or other graphical symbols, within, or superimposed over, the context or region of interest. In the following discussion, an exemplary display problem is employed as the basis for describing the present invention. The exemplary display problem comprises display of points of interest within a displayed map of a portion of a city to a user on a small, hand-held electronic device. However, the exemplary display problem is but one of an essentially limitless number of different problems that may be addressed by various method and system embodiments of the present invention. The exemplary display problem is employed as a concrete problem for describing the present invention, and is not intended to in any way limit the scope of the present invention or claims that follow.

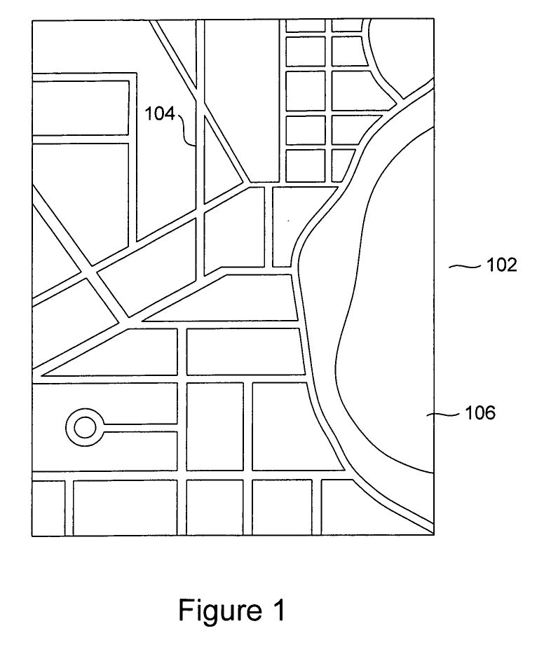

FIG. 1 shows an exemplary display of a region of interest on a display screen of an electronic device. The display screen 102 displays a region of interest comprising a portion of a city, displayed as a road map, with familiar road-map symbols and markings, such as familiar depictions of streets and avenues 104 and a large body of water 106. Only a small portion of the city is displayed, due to constraints of the display-screen size and resolution. Details concerning the display of the region of interest, including selection of the region of interest and possible navigation of the display screen over a larger region containing the region of interest, are outside the scope of the current invention and are not discussed in this document.

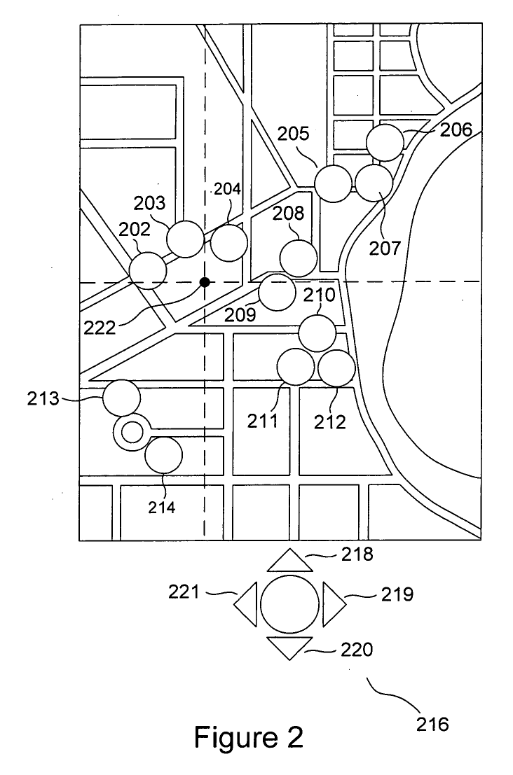

FIG. 2 illustrates display of a number of objects of interest within the exemplary region of interest shown in FIG. 1, along with navigational keys. In FIG. 2, 13 objects of interest, or points of interest, 202-214 are displayed as disk-shaped graphical icons within the map of the portion of the city. A set of navigational keys 216, including an up arrow 218, a right arrow 219, a down arrow 220, and a left arrow 221, allow a user to move a cursor 222 to overlay any of the displayed points of interest for display of additional information about, or user interaction relevant to, the point of interest over which the cursor is positioned. Additional information and additional user interaction may include, for example, scheduling a visit to the point of interest, purchasing tickets for a performance at the point of interest, receiving more detailed directions to the point of interest, and receiving additional descriptive information about the point of interest. The points of interest may be initially selected by user input, or may alternatively be selected automatically by consideration of the selected region of interest, stored user preferences, stored information about the region of interest, a stored of previous user selections, and other store or user-supplied information. Details concerning initial selection of the points of interest by the user are generally outside the scope of the current invention and are not discussed in this document.

The display system and method, embodied in FIG. 2, allows for display of numerous points of interest and for user selection of individual points of interest for various purposes, as discussed above. However, there are significant disadvantages associated with this display system and method. First, as the number of points of interest increases, the underlying city map may become increasingly obscured by point-of-interest icons. Even in FIG. 2, various intersections, such as the intersection underlying the graphical icon displayed for point of interest 207, are obscured. Second, moving the cursor 222 using the navigation keys 216 may be awkward and time consuming for a user, potentially requiring numerous key strokes to select any given point of interest. Attempts to ameliorate map obscuration by decreasing icon sizes may lead to increasingly difficult and frustrating cursor-based point-of-interest selection. Limiting the number of points of interest displayed at a single time would lead to a multi-screen method, with attendant computational overhead, time delays for redrawing the screen, and additional screen-selection keys or methods.

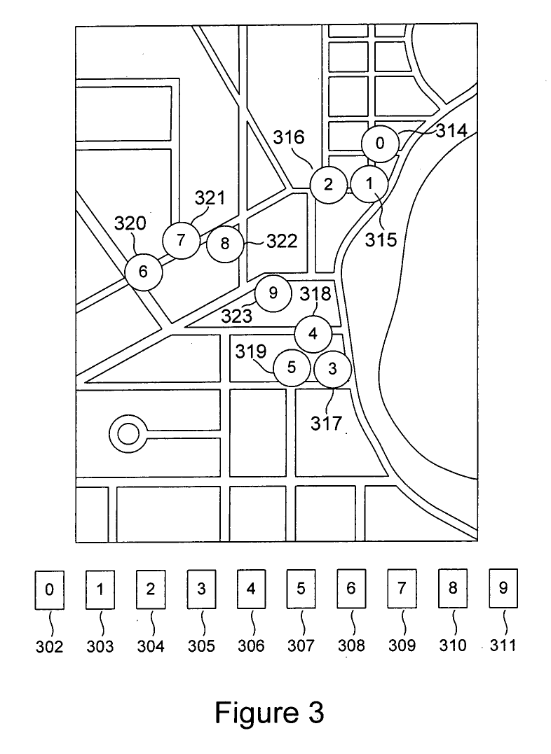

FIG. 3 illustrates display of a portion of the number of objects of interest shown in FIG. 2, along with corresponding keys, within the exemplary region of interest shown in FIG. 1. FIG. 3 shows an alternative display method in which 10 numerically labeled keypad keys 302-311, such as keys of a cell-phone keypad, are used in association with up to 10 numerically labeled points-of-interest icons 314-323. Only up to 10 points of interest are displayed at any given time, so that there is a one-to-one correspondence between displayed points of interest and keypad keys, allowing a user to select any particular displayed point of interest for additional information display or additional user interaction by depressing the corresponding numerically labeled keypad key. This method eliminates the cumbersome cursor-based navigation, but only at the expense of incurring a multi-screen display, when more than 10 points of interest are initially selected for display. Multi-screen display suffers the above-mentioned disadvantages, as well as the disadvantage of partitioning the points of interest among different displays, so that the whole context of the initially selected set of points of interest is lost. For example, a user may have selected display of museums, intending to devise a tour of various museums to fit his or her schedule and transportation means. When the points of interest are partitioned among multiple, separate displays, the user may be required to page back and forward through multiple display screens in order to assimilate the relative locations of museums displayed on multiple screens.

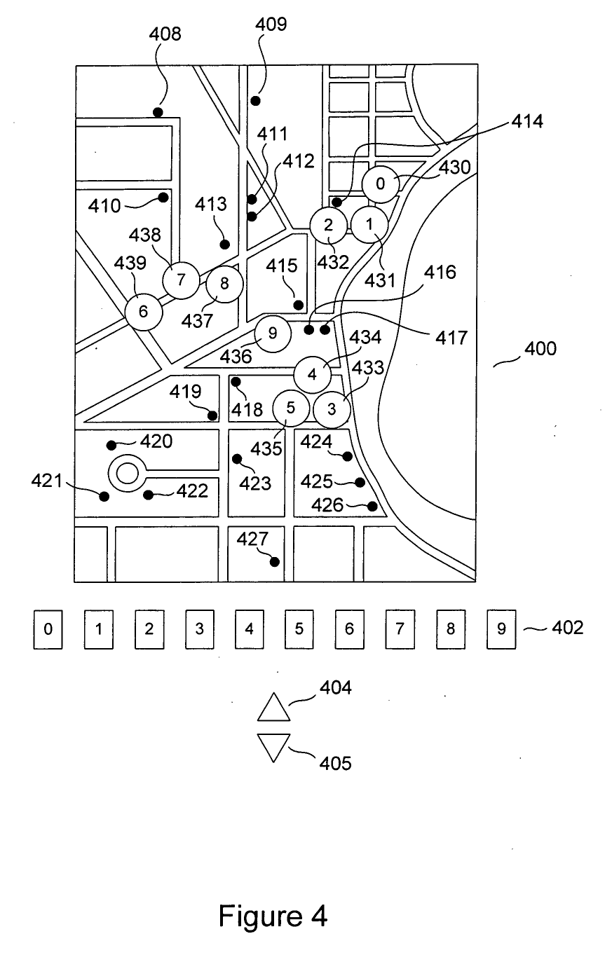

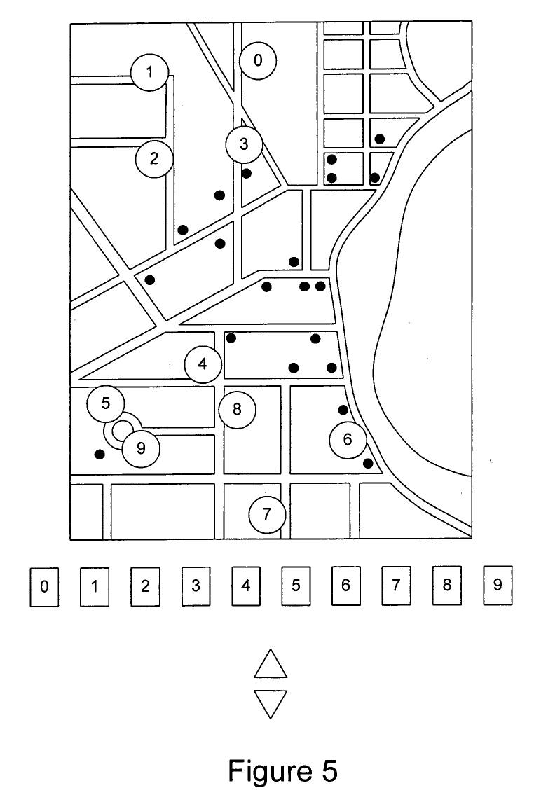

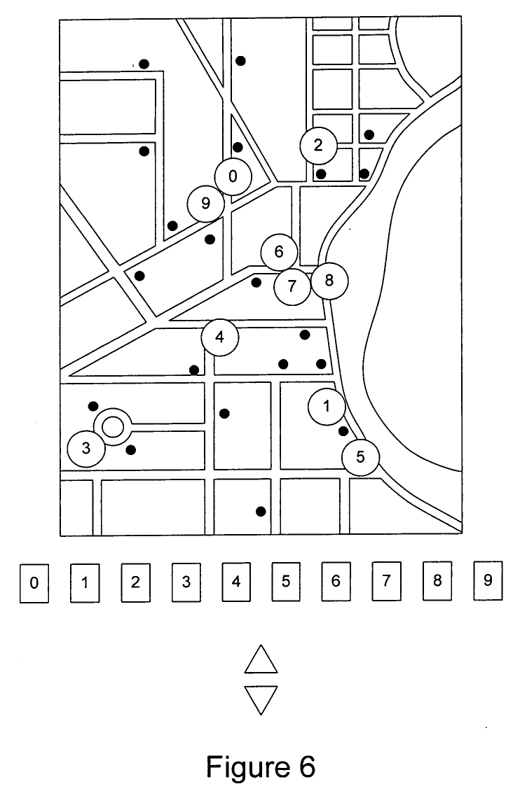

To address the disadvantages of the display systems and methods illustrated in FIGS. 2-3, system and method embodiments of the present invention have been devised. FIGS. 4-6 illustrate of a large number of objects of interest within the exemplary region of interest shown in FIG. 1 according to one embodiment of the present invention. FIGS. 4-6 illustrate display of points of interest, according to one embodiment of the present invention, on a relatively low-resolution display screen 400 in association with numerically labeled keys 402, as in the method shown in FIG. 3, and with forward 404 and reverse 402 object emphasis keys. In the embodiment of the present invention illustrated in FIGS. 4-6, 30 points of interest are displayed within the city map, including 20 deemphasized points of interest 408-427 displayed with relatively small, point-like graphical icons and 10 emphasized points of interest 430-439 displayed with relatively large graphical icons that can accommodate a numeric label on the relatively low-resolution display screen. Each of the emphasized points of interest can be selected for display of additional information or for additional user interaction by depressing the correspondingly labeled keypad key. As shown in FIGS. 5 and 6, two additional portions, or banks, of 10 displayed points of interest can be emphasized by depressing the forward emphasis key 404 once, to emphasize a first, alternative bank of points of interest, shown in FIG. 5, and twice, to emphasize a second, alternative bank of points of interest, shown in FIG. 6. Banks of points of interest may be selected for emphasis both in a forward direction, as shown in the sequence of figures corresponding to FIGS. 4, 5, and 6, or in a reverse direction, by depressing the reverse emphasis key 405, as shown by the sequence of figures corresponding to FIGS. 6, 5, and 4.

Unlike the two previously discussed display systems and methods, shown in FIGS. 2-3, the display system and method that represents one embodiment of the present invention can display a large number of points of interest without obscuring the underlying city map, so that the entire context of the entire group of initially selected points of interest is displayed at one time, within the overall context of the underlying region of interest. But, although a large number of points of interest are simultaneously displayed, cursor-based navigation is unnecessary, since each of the emphasized points of interest is associated with a corresponding keypad key, for single-key-mediated selection, and since any point of interest may be easily emphasized by one or a few depressions of the forward 404 or reverse 405 emphasis key. In certain embodiments of the present invention, the partitioning of points of interest, or objects of interest in more general applications, may be fixed, while in alternative embodiments, the partitioning my vary over time, as a result of user interaction, or based on other considerations. While a bank of 10 emphasized objects is a natural size for cell-phone embodiments, in which 10 numeric keys are prominently arranged for ease of selection, larger or smaller banks of emphasized objects may be convenient for alternative applications. For example, a personal-computer display may employ 36 or more alphanumerically labeled emphasized graphical icons, each associated with a corresponding alphanumeric-symbol-labeled keyboard key. Any of multiple different keys may be employed for selecting one of numerous banks of objects of interest for emphasis. In yet alternative embodiments, voice-recognition technology may be used for user selection of objects of interest and selection of a bank of objects of interest for emphasis.

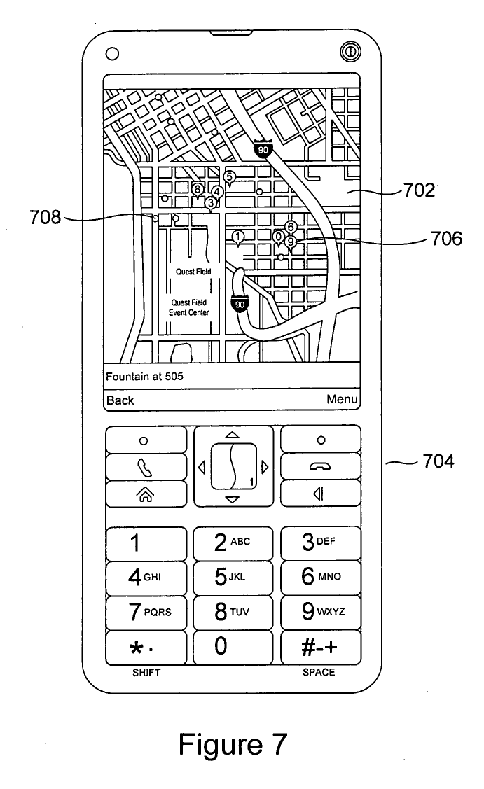

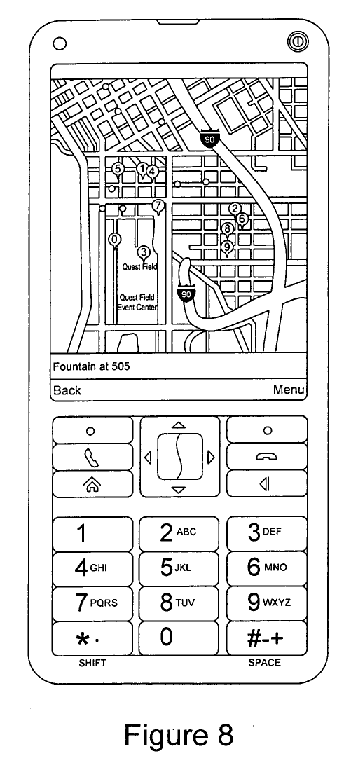

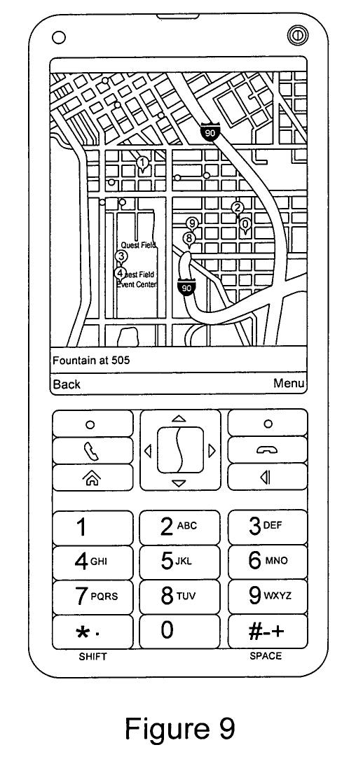

FIGS. 7-9 illustrate display of a large number of objects of interest within an exemplary region of interest, according to one embodiment of the present invention, on a display screen of a cell phone. The cell phone 704 includes a display screen 702 that displays a map of a portion of the city of Seattle, and various emphasized points of interest, such as point of interest 706, and various deemphasized points of interest, such as deemphasized point of interest 708. Using the up-arrow key, different banks of 10 points of interest can be selected for emphasis, as shown in FIGS. 8 and 9.

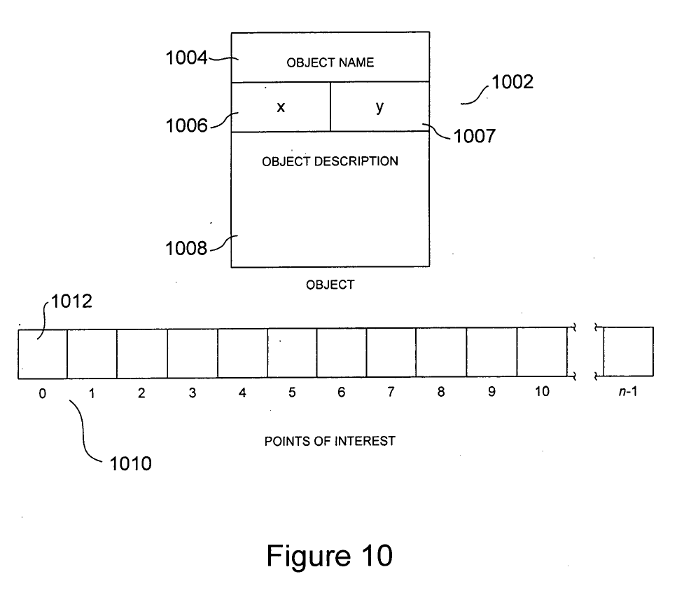

Next, an implementation of one embodiment of the present invention is discussed, with reference to a number of control-flow diagrams. FIG. 10 shows data structure in one implementation of the present invention. An object data structure is a record or structure 1002 that may include an object name 1004, x and y display coordinates 1006-1007 for display of the object, either relative to the display screen or the underlying city map, and an object-description field 1008 that includes text that can be displayed as additional information when the point of interest display icon for the object is selected by a user from the graphical user interface. The various, initially selected points of interest are each represented by an object data structure 1002, and an array of object data structures 1010 is used to stored all of the object data structures corresponding to the initially selected points of interest, such as object data structure 1012.

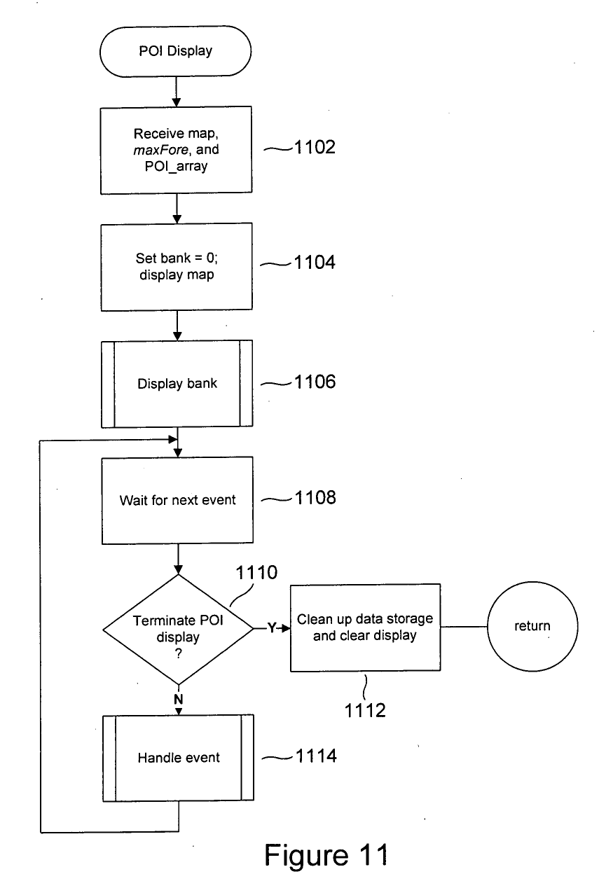

FIG. 11 is a control-flow diagram for a routine “POI Display” that represents one embodiment of the present invention. The routine “POI Display” displays points of interest within a map, as discussed above with reference to FIGS. 4-6 and 7-9. In step 1102, the routine “POI Display” receives an array of n object data structures, “POI_array,” containing descriptions of the points of interest selected for display, a map to display, and a constant maxFore that specifies the maximum number of points of interest to be displayed in the foreground, or, in other words, in a bank of emphasized points of interest. In step 1104, a local variable bank is set to 0, the index of the first object-data-structure entry in the array of points of interest, and the map is displayed to the display screen. Then, in step 1106, a routine “display bank” is called to display the map, a first bank of points of interest as large, foreground icons, and any remaining points of interest as small, point-like icons. Then, the routine “POI Display” enters a continuous loop comprising steps 1108, 1110, and 1114, in which the routine “POI Display” waits for a next event, in step 1108 and handles the next detected event by calling the routine “handle event,” in step 1114, until, in step 1110, a termination event is detected which causes the routine “POI Display” to clean up any data-storage resources used by the routine “POI Display,” clear the display, and exit.

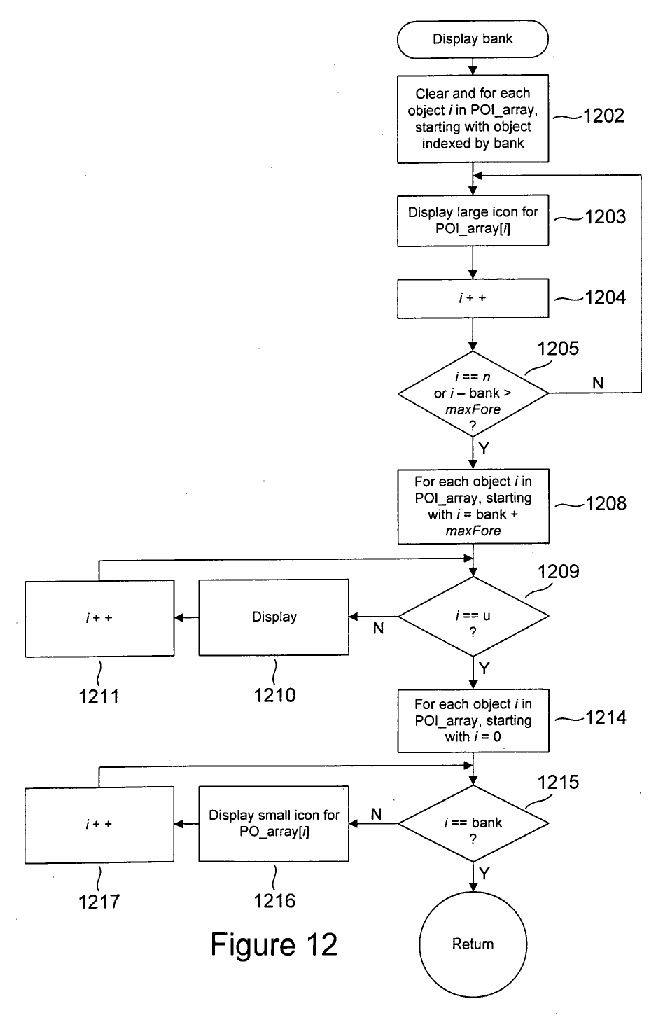

FIG. 12 is a control-flow diagram of a routine “display bank” called in step 1106 of the routine “POI Display,” discussed with reference to FIG. 11. In step 1202, any currently displayed points of interest are first cleared and then, in the for-loop of steps 1202-1205, starting with local variable i equal to local variable bank, the successive elements of POI-array, POI-array[i], are displayed as large icons up to either maxFore points of interest or up through the last point of interest in POI-array, whichever comes first. Then, in the for-loops of steps 1208-1211 and 1214-1217, any remaining points of interest in the array POI-array are displayed as small icons.

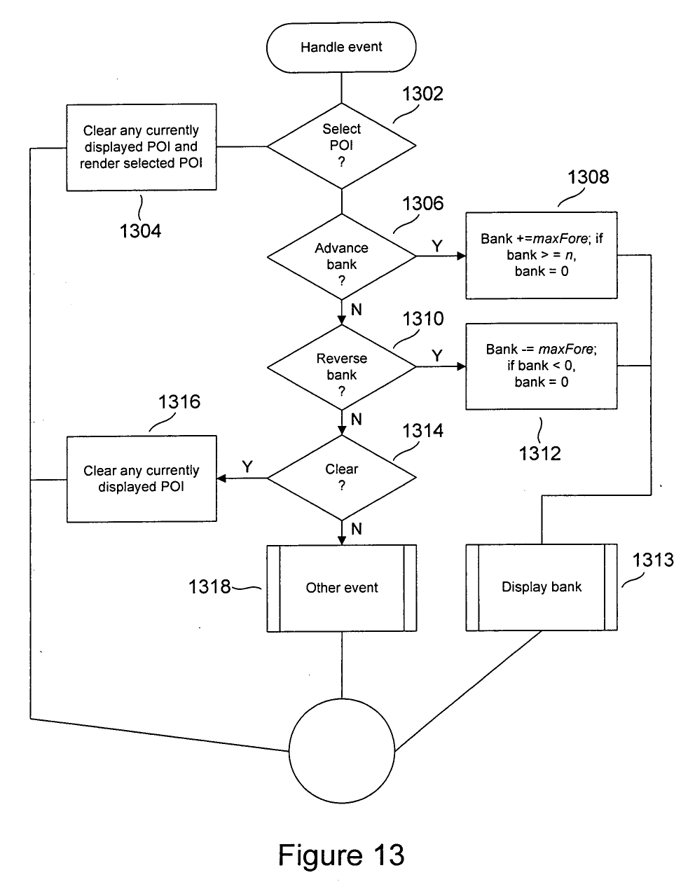

FIG. 13 is a control-flow diagram for a routine “handle event” called in step 1114 of the routine “POI Display,” discussed with reference to FIG. 11. If the most recently detected event is a user selection of an emphasized point of interest, as detected in step 1302, then, in step 1304, any currently displayed additional display of information relevant to a previously selected point of interest is cleared, and the currently selected point of interest is rendered to the user, by displaying additional information from the “object description” field of the object data structure corresponding to the point of interest, initiating addition user interaction related to the selected point of interest, by a combination of information display and user interaction, or by another method. Otherwise, if the most recently detected event is a user depression of the forward emphasize key, to select a next bank of objects for display, as determined in step 1306, then, in step 1308, the variable bank is incremented by maxFore, with an increment past n−1 resulting in bank set to 0, and the routine “display bank” is called in step 1313. Otherwise, if the most recently detected event is a user depression of the reverse emphasize key, to select a preceding bank of objects for display, as determined in step 1310, then, in step 1312, the variable bank is decremented by maxFore, with a decrement past 0 resulting in bank set to 0, and the routine “display bank” is called in step 1313. Otherwise, when the most recently detected event is a user request to clear a current display of information related to a previously selected point of interest, as determined in step 1314, the information display is cleared in step 1316. Otherwise, if any other vent has occurred, then a generalized event handler is called, in step 1318.

In an alternative embodiment, increments and decrements in steps 1308 and 1312 may be made by modulo n arithmetic, and the routine “display bank” modified, so that every bank has maxFore members, and so that the contents of the banks change, over time, when n is not a multiple of maxFore. Many other methods for rotating the bank through the initially selected objects of interest, including various methods for considering user input to determine how rotation occurs.

Although the present invention has been described in terms of a particular embodiment, it is not intended that the invention be limited to this embodiment. Modifications within the spirit of the invention will be apparent to those skilled in the art. For example, a nearly limitless number of different implementations of display systems and methods that represent embodiments of the present invention may be obtained by using any of a large number of different programming languages for implementations on any of many different operating-system and hardware platforms; using various different data structures, control structures, modular organization, and by varying other such implementation parameters. Alternatively, display systems of the present invention may be implemented wholly or partially in logic circuits. Objects of interest, as discussed above, may be any of many different types of information or data that is manually or automatically selected for display to a user, within the context of an area of interest, including geographical locations of interest within a geographical area of interest, items or components of a larger entity, such as machine parts of a machine, text components of a literary work, words or phrases within a document, merchandise or display counters within a store, web sites in a network of interconnected web sites, items within an electronic catalogue, and many other such data and information within many other specialized contexts. Banks of objects emphasized for display may contain various different numbers of objects of interest, depending on constraints such as display area, necessary associations with input-device components, and other such constraints. Banks may be static or may change dynamically. In certain embodiments, one bank of objects of interest are displayed with emphasis, using large icons that provide for user selection, another portion of the objects of interest are displayed using small icon and thus deemphasized, and a third portion of the objects of interest are not displayed, in order to not unnecessarily clutter the display screen. In such embodiments, objects of interest may migrate from the bank of emphasized objects of interest to the deemphasized portion of the objects of interest and from the deemphasized portion of the objects of interest to the undisplayed portion of the objects of interest, and in the reverse direction, by various types of user input. In the above-described embodiments, the icons used to graphically represent objects of interest have similar sizes, shapes, and colors. However, in alternative embodiments, the icons may encode additional information in different sizes, shapes, and colors. For example, in one embodiment of the present invention, when objects of interest are emphasized, or promoted, their shapes and colors reflect the types of objects on interest and other characteristics or attributes of the emphasized objects of interest. Types on objects of interest include events, places, friends, items for sale, displayed items of interest, and other such types of objects of interest. Attributes include whether or not the object of interest has been bookmarked by a user, whether or not the object of interest is popular within an interest group, whether or not the object of interest is static or dynamic in place or time, and other such attributes. It should be noted that, in general, an object of interest can be anything of interest to a user and having a location at some point in time.

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description; they are not intended to be exhaustive or to limit the invention to the precise forms disclosed, obviously many modifications and variations are possible in view of the above teachings. The embodiments were chosen and described in order to best explain the principles of the invention and its practical applications and to thereby enable others skilled in the art to best utilize the invention and various embodiments with various modifications as are suited to the particular use contemplated. It is intended that the scope of the invention be defined by the following claims and their equivalents:

1. A display system for displaying objects of interest within a displayed area of interest, the display system comprising:
a display screen on which a representation of the area of interest and representations of each object of interest are displayed;
input components;
electronically encoded data that describes the area of interest and objects of interest; and
control logic that
uses the electronically encoded data to display the representation of the area of interest on the display screen,
emphasizes a first portion of the objects of interest by using the electronically encoded data to display a first type of graphical representation on the display screen to represent each of the first portion of the objects of interest and provide for selection of each of the first portion of the objects of interest, and
deemphasizes a second portion of the objects of interest by using the electronically encoded data to display a second type of graphical representation on the display screen to represent each of the second portion of the objects of interest.

2. The display system of claim 1 wherein each graphical representation of the first type of graphical representation is larger than any graphical representation of the second type of graphical representations.

3. The display system of claim 1 wherein each graphical representation of the first type of graphical representation is labeled with a label associated with a corresponding input component to allow for selection of the object of interest represented by a graphical representation of the first type of graphical representation including a particular label by input to the corresponding input component associated with the particular label.

4. The display system of claim 1 wherein the control logic further provides for selection of a different portion of the objects of interest for emphasis by display of the first type of graphical representation on the display screen to represent each of the different portion of the objects of interest and provide for selection of each of the different portion of the objects of interest.

5. The display system of claim 4 wherein the objects of interest are partitioned into a number of banks of objects of interest, a first bank emphasized by displaying the first type of graphical representation on the display screen to represent each of the objects of interest in the first bank and provide for selection of each object of interest in the first bank and the remaining banks deemphasized by displaying the second type of graphical representation on the display screen to represent each of the objects of interest in the remaining banks.

6. The display system of claim 5 wherein emphasis is rotated among the banks of objects by input received through one or more input components.

7. The display system of claim 1 wherein the area of interest is a geographical area and wherein objects of interest have geographical locations within the geographical area.

8. The display system of claim 1 wherein objects of interest within the area of interest include:
events;
friends;
items for sale;
displayed items;
buildings;
public facilities;
transportation centers;
viewpoints;
components of a device or machine within the device or machine;
items within a store;
items within an electronic catalogue;
websites within a network of websites; and
words or phrases within a document.

9. The display system of claim 1 wherein a user of the display system can select an emphasized object of interest for display of additional information related to the selected emphasized object of interest.

10. The display system of claim 1 wherein a user of the display system can select an emphasized object of interest for additional user interaction related to the selected emphasized object of interest.

11. The display system of claim 1 included in a hand-held electronic device, wherein input components include keys of a keypad.

12. A method for displaying objects of interest within a displayed area of interest, the method comprising:
assigning each object of interest to either a first portion of emphasized objects of interest that are selectable or to a second portion of deemphasized objects of interest;
displaying the area of interest;
displaying a graphical representation of a first type of graphical representation for each object of interest in the first portion of emphasized objects of interest; and
displaying a graphical representation of a second type of graphical representation for each object of interest in the second portion of deemphasized objects of interest.

13. The method of claim 12 further including:
displaying a label, as part of each graphical representation of the first type of graphical representation, that is associated with an input component; and
selecting the object of interest associated with a particular label when the input component associated with the particular label is activated.

14. The method of claim 12 wherein objects of interest are reassigned to the first portion of emphasized objects and the second portion of deemphasized objects in response to input received through one or more input components.

15. The method of claim 14 further comprising partitioning the objects of interest into a number of banks of objects of interest, a first bank of objects of interest emphasized by displaying the first type of graphical representation on the display screen to represent each of the objects of interest in the first bank and provide for selection of each object of interest in the first bank of objects of interest and the remaining banks of objects of interest deemphasized by displaying the second type of graphical representation on the display screen to represent each of the objects of interest in the remaining banks.

16. The method of claim 15 wherein emphasis is rotated among the banks of objects by input received through one or more input components.

17. The method of claim 12 wherein the area of interest is a geographical area and wherein objects of interest have geographical locations within the geographical area.

18. The method of claim 12 wherein objects of interest within the area of interest include:
events;
friends;
items for sale;
displayed items;
buildings;
public facilities;
transportation centers;
viewpoints;
components of a device or machine within the device or machine;
items within a store;
items within an electronic catalogue;
websites within a network of websites; and
words or phrases within a document.

19. The method of claim 12 further comprising providing for input-invoked selection of an emphasized object of interest for display of additional information related to the selected emphasized object of interest.

20. The method of claim 12 further comprising providing for input-invoked selection of an emphasized object of interest for user interaction related to the selected emphasized object of interest.

21. The method of claim 12 employed in a hand-held electronic device, wherein input components include keys of a keypad.

22. Computer instructions encoded in a computer-readable medium that implement the method of claim 12.
